(19) United States
(12) Patent Application Publication
(10) Pub. No.: US 2026/0178628 A1
(43) Pub. Date: Jun. 25, 2026

(54) METHODS AND SYSTEMS FOR ANALYZING HUMAN QUERIES

(71) Applicant: BP International Limited, Middlesex (GB)

(72) Inventors: Ashley Messer, Houston, TX (US); Joseph Hall, Surrey (GB); Nada Hijazi, Houston, TX (US); Frederik Heda, Surrey (GB); Zaki Pauzi, Surrey (GB)

(73) Assignee: BP International Limited, Middlesex (GB)

(21) Appl. No.: 19/427,618

(22) Filed: Dec. 19, 2025

Related U.S. Application Data
(60) Provisional application No. 63/737,391, filed on Dec. 20, 2024.

(51) Int. Cl. G06F 16/3329; G06F 16/334; G06F 40/289

(52) U.S. Cl. CPC G06F 16/33295; G06F 16/3347; G06F 40/289

(57) ABSTRACT

A computer-implemented method for answering human queries received by a user includes receiving by a document processing module, a document from a document source; identifying by a document chunking engine of the document processing module, a first set of chapter headers contained in a table of contents of the document; identifying by the document chunking engine, a second set of chapter headers in a body of the document that is separate from the table of contents; matching by the document chunking engine one or more chapter headers of the first set of chapter headers with one or more chapter headers of the second set of chapter headers to provide a third set of matched chapter headers; dividing the document into a plurality of chunks based on the third set of matched chapter headers; and storing the plurality of chunks of the document in a datastore.

### CROSS-REFERENCE TO RELATED APPLICATIONS

This application is a non-provisional application which claims benefit of U.S. provisional patent application No. 63/737,391 filed Dec. 20, 2024, and entitled “Methods and Systems for Analyzing Human Queries,” which is hereby incorporated herein by reference in its entirety for all purposes.

### STATEMENT REGARDING FEDERALLY SPONSORED RESEARCH OR DEVELOPMENT

Not applicable.

### BACKGROUND

In today's digital age, question and answer systems have become increasingly prevalent in various applications from client support to educational tools and artificial intelligence systems. A question and answer system is defined as a system that retrieves information from one or more data sources and leverages that information to respond to a user query received by the question and answer system. For example, a question and answer system may search a database or document source for a suitable answer responsive to a query submitted by a user or an input device. The answer may be one word, a text fragment, a well-constructed sentence, or a collection of sentences with logical coherence. The answer type may depend on the application for which a question and answer system is developed. For example, a question and answer system may be developed based on database querying, information retrieval, or knowledge graphs. Upon receiving a query, such systems are designed to automatically identify and retrieve pertinent information, synthesize their content, and generate an answer or a response to the query.

### BRIEF SUMMARY OF THE DISCLOSURE

In an embodiment, a computer-implemented method for answering queries received by a user comprises (a) receiving by a document processing module, a document from a document source; (b) identifying by a document chunking engine of the document processing module, a first set of chapter headers contained in a table of contents of the document; (c) identifying by the document chunking engine, a second set of chapter headers in a body of the document that is separate from the table of contents; (d) matching by the document chunking engine one or more chapter headers of the first set of chapter headers with one or more chapter headers of the second set of chapter headers to provide a third set of matched chapter headers; (e) dividing the document into a plurality of chunks based on the third set of matched chapter headers; and (f) storing the plurality of chunks of the document in a datastore. In some embodiments, the method further comprises (g) embedding the plurality of chunks as a plurality of multi-dimensional vectors and (f) comprises storing the plurality of chunks as the plurality of vectors in the datastore. In certain embodiments, (c) comprises (c1) providing a prompt to a generative model instructing the generative model to identify the second set of chapter headers in the body of the document; and (c2) receiving from the generative model the second set of chapter headers. In other embodiments, (c1) comprises iteratively providing a set of the prompts to the generative model associated with different portions of the body of selected document. In some embodiments, (c2) comprises receiving iteratively from the generative model the second set of chapter headers. In certain embodiments, each of the plurality of chunks corresponds to a unique chapter of the body of the document. In other embodiments, at least some of the plurality of chunks corresponds to a unique chapter of the body of the document.

In an embodiment, a computer-implemented method for answering queries received by a user comprises (a) receiving by a user interface of an interface module, a query from a user; (b) providing by a search engine of a retrieval module, a search query directed towards a document source for identifying one or more documents relevant to answering the query; (c) receiving by a validation engine of the retrieval module, a search result indicative of one or more documents of the document source in response to providing the search query; (d) validating by a validation engine of the retrieval module, the search result to identify one or more responsive documents; (e) providing by the interface module a query prompt to a generative model, the query prompt containing the user query and a query context corresponding to information identified in the search result; (f) receiving by the interface module, an answer generated by a generative model, the answer being responsive to the user query and based on the query context; and (g) providing by the user interface of the interface module the answer to the user. In some embodiments, the method further comprises (h) dividing by a query chunking engine of a query processing module the query into a plurality of chunks. In certain embodiments, the method further comprises (h) embedding by a query embedding engine of the query processing module the plurality of chunks as an embedded query comprising a plurality of multi-dimensional query vectors. In other embodiments, the method further comprises (h) identifying by a scope identification engine, if the query is within a predefined answer scope. In some embodiments, (h) comprises (h1) providing by the scope identification engine a scope prompt instructing the generative model to generate a scope determination of the query; and (h2) receiving by the scope identification engine 24 the scope determination generated by the generative model. In certain embodiments, the scope prompt both instructs the generative model to generate a scope explanation if the query is within the predefined answer scope, and to determine if the query is within the answer scope based on the generated scope explanation. In other embodiments, (b) comprises iteratively providing by the search engine of a retrieval module a set of different search queries directed towards the document source. In some embodiments, (c) comprises receiving iteratively by the validation engine a set of different search results until a final search result is received that addresses each of one or more answer requirements determined by the retrieval module, which must be addressed in order to generate a valid answer.

In an embodiment, a computer-implemented method for answering queries received by a user comprises (a) receiving by a user interface of an interface module a query from a user; (b) retrieving by a search engine of a retrieval module, a search result indicative of one or more documents obtained from a document source in response to the retrieval module receiving the user query; (c) providing by the interface module, a query

prompt to a generative model, the query prompt containing the user query and a query context corresponding to information identified in the search result; (d) receiving by the interface module, an answer generated by a generative model, the answer being responsive to the user query and based on the query context; (e) providing by a groundedness filter of the interface module, a groundedness prompt to the generative model, the groundedness prompt containing the answer and instructions to the generative model to generate a groundedness score quantifying a groundedness of the answer based on the query context; (f) receiving by the groundedness filter, the groundedness score generated by the generative model; and (g) providing by the user interface of the interface module to the user, the answer generated by the generative model in response to the groundedness score meeting or exceeding a groundedness threshold. In some embodiments, the groundedness prompt comprises both instructions to generate a groundedness explanation of the groundedness of the answer, and to determine the groundedness score based on the groundedness explanation. In certain embodiments, the method further comprises (h) providing by the groundedness filter an updated groundedness prompt to the generative model instructing the generative model to provide an updated answer having a groundedness score that exceeds the groundedness threshold. In other embodiments, the method of claim 16, wherein the groundedness score corresponds to an amount of information contained in the answer that is included in the query context. In some embodiments, (f) comprises receiving by the groundedness filter an updated groundedness score generated by the generative model and based on an updated answer; and (g) comprises providing by the user interface of the interface module to the user, the answer generated by the generative model in response to the updated groundedness score meeting or exceeding the groundedness threshold.

### BRIEF DESCRIPTION OF THE DRAWINGS

For a detailed description of exemplary embodiments of the disclosure, reference will now be made to the accompanying drawings in which:

FIG. 1 is a block diagram of an exemplary question and answer system in accordance with principles disclosed herein;

FIG. 2 is a flowchart of an exemplary embodiment of a document chunking process undertaken by the document chunking engine of FIG. 1 in accordance with principles disclosed herein;

FIGS. 3A, 3B, and 3C are block diagrams illustrating the steps undertaken in the document processing module of FIG. 1 in accordance with principles disclosed herein.

FIG. 4 is an exemplary schematic diagram illustrating processes undertaken by the document chunking and embedding engines of FIG. 1 in accordance with principles disclosed herein;

FIG. 5A-G are block diagrams illustrating exemplary processes implemented or executed by the question and answer system of FIG. 1 in accordance with principles disclosed herein;

FIG. 6 is a block diagram of an embodiment of a computer system for implementing a question and answer system in accordance with principles disclosed herein; and

FIG. 7 is a flow diagram of an embodiment of a computer-implemented method for answering queries;

FIG. 8 is a flow diagram of another embodiment of a computer-implemented method for answering queries; and

FIG. 9 is a flow diagram of another embodiment of a computer-implemented method for answering queries.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

Question and answer (Q&A) systems generate responses or answers based on a user inquiry or query. For example, a Q&A system may be configured to provide responses to legal queries relating to contracts, agreements, terms and conditions, etc., that are specific to an organization. In this example, the Q&A system is configured to provide a response or answer by searching a database of legal documents and/or case law to find relevant information based on a user's query. As will be discussed further herein, in at least some instances, the Q&A system may be implemented using a retrieval augmented generation (RAG) architecture that works in conjunction or leverages one or more generative models such as large language models (LLMs) when answering user queries and/or processing user-provided documents.

In addition, relatively large documents or data may be divided or broken down by the Q&A system into smaller segments or chunks before and during processing. This approach, referred to as “chunking,” allows for more efficient processing of information and improves the search for contextual relevance. As used herein, “chunking” refers to breaking down or dividing a large dataset or document into smaller, manageable segments called “chunks.” Each chunk may then be indexed and stored for later retrieval. For example, a Q&A system may divide a document into smaller logical chunks or segments based on criteria such as paragraph breaks, number of sentences, number of characters, and the like. These segments are then indexed and stored, often with metadata describing their content or context. In at least some instances, the chunks may be stored following their embedding as numerical vectors as will be discussed further herein.

Generally, Q&A systems first pre-process the user-provided query or document. In this manner, when a query is received, the Q&A system may automatically chunk the query to capture, as efficiently as possible, the underlying semantic context contained in the query (this captured semantic context may be stored as numerical vectors, plain text, etc.). For instance, the chunks may be sized to efficiently capture the semantic context contained in the underlying text while avoiding capturing unrelated information or noise that could otherwise obscure the captured semantic context or decrease the computational efficiency of the Q&A system. In this manner, the Q&A system, having captured the semantic context contained in the query may then identify and retrieve previously saved chunks of information (e.g., stored in the form of plain text or as numerical vectors in a database of the Q&A system such a Structured Query Language (SQL) database, a vector database, and the like) based on their relevance to the query (e.g., based on the similarity of the embedded vectors corresponding to the selected chunks) to provide an answer or response to the query. In order words, when a user query is received, the Q&A system may use one or more algorithms (e.g., semantic similarity matching, keyword analysis, advanced natural language processing techniques, and the like) to identify and retrieve the most relevant segments or chunks (stored or embedded as numerical vectors in a database, for instance) based on the user query. The most relevant chunks are analyzed based on, for example, entity identification, relationship extraction, summaries, and so on, to generate an answer. In some embodiments, the Q&A system may integrate information from multiple sources, documents or databases if necessary, to provide an answer to a query. In some instances, the documents to be searched may be uploaded or otherwise specified by the user when making the query.

Consistent with the above, in some instances, chunks may be transferred to models that can understand context and generate answers based on the context. For example, in Q&A systems that leverage the RAG architecture, relevant chunks may be provided to a generative model (e.g., an LLM) configured to generate a textual answer based on the semantic context captured in the provided chunks. This chunking approach allows the Q&A system to handle large documents and queries more efficiently and provide relevant answers quickly, efficiently, and accurately. The manner in which the user-provided query or document is chunked, such as the size or length of the individual chunks, may substantially impact the information returned by the Q&A system in answering the query. For example, a chunk size that is too large may result in substantial memory and computational costs to the Q&A system while inhibiting the Q&A system from focusing on all of the information contained in the chunk such that answers provided by the Q&A system may not reflect the entirety of the query. Conversely, for chunk sizes that are too large, the semantic context contained in the query or user-provided document may be lost and thus not captured in the chunks and ultimately the numerical vectors determined therefrom.

In the context of Q&A systems leveraging RAG architectures, the Q&A system may, after processing a user-provided query and/or document, provide an input containing one or more chunks (referred to as a “prompt”) and the user input or a representation of the user input to a generative model in signal communication with the Q&A system to thereby generate an answer or response that is relevant to the query. The amount of information contained in the prompt is sometimes referred to as the “context size” of the prompt where the choice of context size plays a pivotal role in achieving accurate and coherent answers. Particularly, as used herein “context size” refers to the amount of information (e.g., the number of tokens) provided by the Q&A system to the generative model to generate an answer to a user-provided query. The information contained in the prompt provided to the generative model (the size of which defines the context size) may encompass both a user-provided query as well as additional information identified by the Q&A system as relevant for answering the query, such as information contained in user-provided documents. Typically, the context size of the prompt provided by the Q&A system to the generative model must be equal to or less than a predefined context window of the generative model. As used herein, the term “context window” refers to the total amount of information that a given generative model may process at a single time. The context window may be defined as a maximum number of tokens acceptable by the generative model at a single time, where each token corresponds to a fundamental unit of text utilized by the generative model.

Finding the right balance between too much and too little information contained in the chunks produced and used by Q&A systems is crucial for the effectiveness (e.g., in terms of accuracy, memory and/or computational complexity) of the Q&A system. For instance, when the chunk size is excessively large, it can introduce noise and irrelevant information while also substantially increasing the memory and computational demands on the Q&A system and the generative model leveraged by the Q&A system in generating answers to the user-provided queries. Additionally, as described above, the chunk size may not exceed the context window of the generative model used by the Q&A system. Moreover, while certain generative models have relatively large context windows (e.g., context windows sufficient to encompass entire books or extensive articles, white papers, monographs, and the like), the inclusion of such excessive amounts of information in the prompt provided to the generative model can lead to overfitting whereby irrelevant details contained in the prompt dilute the generative model's ability to focus on the specific query and relevant content. For instance, even for generative models having a large context window, such models may have issues with long-range dependencies whereby the generative model may forget or discount portions of the prompt provided thereto when generating a return to the prompt. Further, excessively large chunk sizes may substantially increase the computational complexity during inference. Conversely, limiting the chunk size too much can result in incomplete answers by failing to provide the generative model with the semantic context required to accurately and completely answer the query. For instance, without adequate semantic context contained in the prompt provided by the Q&A system, the generative model might provide a generic or ambiguous answer, failing to address the specific nuances of the user query.

Further, the chunk size used for dividing and storing (e.g., as numerical vectors) information contained in user-provided documents to be referenced in answering a corresponding user query may also substantially impact the accuracy and completeness of the answer ultimately provided by the generative model used by the Q&A system. For example, in Q&A systems that leverage RAG architectures, chunks (e.g., chunks embedded as numerical vectors) generated from the user-provided documents may be matched or otherwise correlated with chunks produced from a user query (similarly embedded as numerical vectors) to identify relevant content contained in the user-provided documents, where the size of chunks produced from the user-provided documents plays a crucial role in determining the answer ultimately provided by the generative model. For instance, embedding a large chunk of content, such as an entire chapter of a user-provided document, instead of a smaller section like a page or paragraph, may lead the Q&A system to identify semantic similarities between the query and the entire chapter rather than the specific passages or text contained in the chapter that are particularly relevant to the user query. In this manner, the presence of irrelevant elements within the larger content can make it difficult for the generative model to generate an accurate and complete answer to the user query.

Conventionally, fixed size chunking, random chunk size, sliding windows, context-aware chunking, and similar strategies have been used in producing chunks from user-provided information such as user queries and user-provided documents. Fixed size chunking strategies may work for fairly homogenous datasets that use content of similar formats and sizes but it generally does not consider the semantic context of the content that is chunked. Additionally, random chunk sizing may work for non-homogenous collection of multiple document types. Particularly, this approach can potentially capture a wider variety of semantic contexts and topics without relying on the conventions of any given document type. However, random chunk sizing might inadvertently break or segregate content across different sentences and paragraphs, leading to meaningless chunks of text or other information. Further, sliding windows can be applied to both fixed size and random size chunking strategies whereby, instead of starting new chunks at the end of the previous chunk, new chunks overlap the underlying content of the previous chunk and thereby contain a portion of the previous chunk. However, this technique increases the memory and computational demands on the Q&A system and/or generative model which can increase processing times in answering queries and performing other tasks.

Moreover, in context-aware or “dynamic” chunking strategies, user-provided documents may be divided based on particular information contained in the document such as punctuation marks or elements like periods, commas, or paragraph breaks or tags. While context-aware chunking considers such contextual clues, it may require additional pre-processing to segment the text, which can increase computational requirements and slow down the chunking process. For instance, in some implementations of context-aware chunking strategies, all relevant documents that relates to a user query may need to be considered when generating an answer. Thus, a balance in the size of the query, the chunks, and the answer may be necessary to achieve optimal system performance depending on the use case.

Accordingly, embodiments of systems and methods are disclosed herein which overcome at least some of the challenges associated with conventional Q&A systems, including Q&A systems that utilize RAG architectures and which leverage separate generative models such as LLMs in generating answers to user queries received by the Q&A system. Particularly, Q&A methods and systems disclosed herein includes a computer-implemented method for answering user queries that leverage context-aware chunking strategies that go beyond conventional techniques to maximize the efficiency and responsiveness of the Q&A system. In some embodiments, Q&A systems described herein identify by a document chunking engine the sections contained within a document using various methods. For example, Q&A systems described herein may identify by a document chunking engine a first set of chapter headers contained in a table of contents of a document and a second set of chapter headers in the body of the document, match one or more chapter headers of the first set of chapter headers with one or more chapter headers of the second set of chapter headers to provide a third set of matched chapter headers, and divide the document into a plurality of separate chunks based on the third set of matched chapter headers. In some instances, the Q&A system may chunk the given document in ways that differ from the exemplary chapter header-based technique described above. In some embodiments, the chunks are stored in a datastore of the Q&A system. For example, the chunks may be stored in a database in the form of plain text, in a database or other data structure in the form of numerical vectors. For instance, the chunks may be stored in a SQL database and/or similar databases. The stored chunks may be conveniently retrieved by the Q&A system in answering user queries pertaining to the chunked documents. As used herein, a “chapter” refers to a demarcation between different topically oriented sections or passages within a body of a document and which may be documented in a table of contents (ToC) of the document that is separate from the body thereof. In other words, although a document may refer to its given “chapters” by other labels, the term chapter as used herein is interpreted broadly as covering different types of topically oriented demarcations intended to divide the body of a document into different topics or subtopics and which may be contained in a separate ToC of the document.

In addition, embodiments disclosed herein includes computer-implemented methods for answering queries received by a user (e.g., via a Q&A system configured to implement the query answering method), which comprises validating by a validation engine of the retrieval module, one or more retrieved documents to identify one or more responsive documents; providing by an interface module a query prompt to a generative model; receiving by the interface module an answer generated by the generative model, the answer being responsive to the user query and based on the one or more responsive documents; and providing by a user interface of the interface module an answer to the user.

Additionally, embodiments disclosed herein includes a computer-implemented method for answering queries received by a user and which comprises retrieving by a search engine of a retrieval module one or more documents from a document source in response to the retrieval module receiving a user query; providing by the interface module a query prompt to a generative model, the query prompt containing the user query and the one or more retrieved documents relevant to the query. Additionally, the method may include receiving by the interface module an answer generated by a generative model, the answer being responsive to the user query and based on the one or more retrieved documents; providing by a groundedness filter of the interface module, a groundedness prompt to the generative model, the groundedness prompt containing the answer and instructions to the generative model to generate a groundedness score quantifying a groundedness of the answer based on the one or more retrieved documents. Further, the method may include receiving by the groundedness filter, the groundedness score generated by the generative model; and providing by the user interface of the interface module the answer to the user, the answer generated by the generative model in response to the groundedness score meeting or exceeding a predefined groundedness threshold.

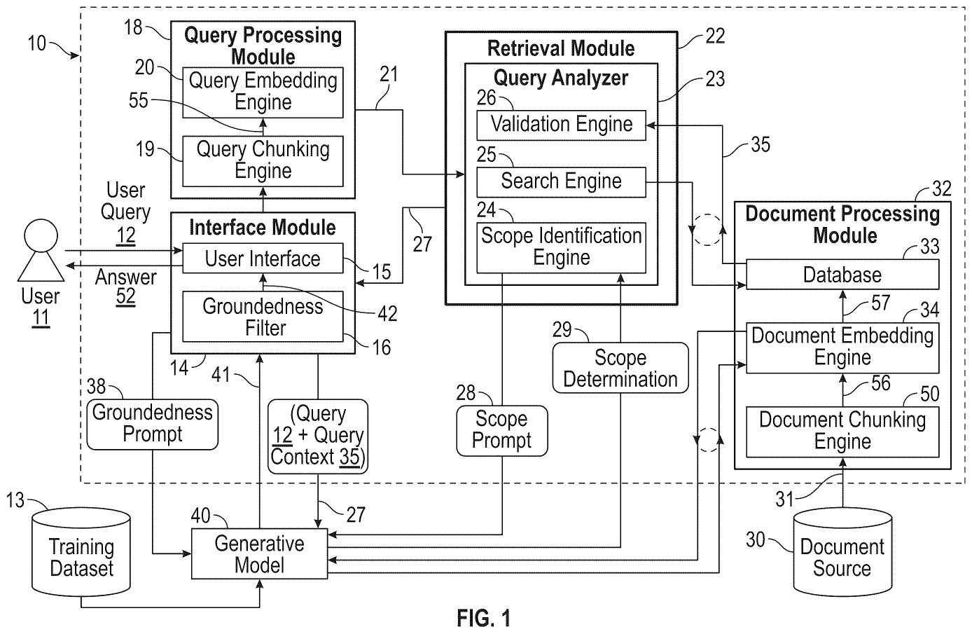

Further, embodiments disclosed herein include chunking, retrieving, and validating the responsive documents leveraging topically oriented or chapter-based chunking strategies to thereby ensure that all relevant documents (e.g., contracts, amendments, side letters, agreements) that relate to a user query are considered when prompting an associated generative model to ultimately generate an answer quickly, accurately, and completely. Additionally, the groundedness filter provides guardrails to ensure that the answer provided is coherent and accurate. As will be discussed further herein, embodiments of systems and methods for analyzing queries in a Q&A system are discussed herein in the context of specific documents such as contracts. However, it may be understood that embodiments of systems and methods for analyzing queries in a Q&A system disclosed herein may extend beyond querying documents. For example, and referring now to FIG. 1, a block diagram of an embodiment of a Q&A system 10 is shown that details various processes that may be undertaken based on receipt of a user query. Although the Q&A system 10 is described in a particular order of operations as will be further detailed herein, it should be noted that the operations of Q&A system 10 discussed herein may be performed in any suitable order.

Particularly, FIG. 1 is a block diagram of an exemplary Q&A system 10 which illustrates processing of a user query 12 provided by a user 11 according to some embodiments. In this exemplary embodiment, Q&A system 10 generally includes an interface module 14, a query processing module 18, a retrieval module 22, and a document processing module 32 configured to receive one or more (e.g., user-provided) selected documents (represented by arrow 31 in FIG. 1) from a document source 30. Additionally, Q&A system 10 is in signal communication (e.g., connected via a network such as the Internet) with a generative model 40 that has been previously trained using a training dataset 13 that may encompass vast sources of information such as from the Internet and/or other large scale networks. Although Q&A system 10 leverages generative model 40 in performing its various tasks, generative model 40, in at least some embodiments, is not a component of Q&A system 10 and is separate from the Q&A system 10. Similarly, in at least some embodiments, document source 30 (and information contained therein) is also separate from the Q&A system 10.

Q&A system 10 is generally configured to provide responses or answers 52 to the user 11 that are responsive to a user query 12 sent or inputted to the Q&A system 10 by a user 11 via the interface module 14 of Q&A system 10. The user query 12 may be a question in the form of, for example, natural language or text received via a user interface (UI) 15 of the interface module 14 of Q&A system 10, a conversation (i.e., multiple preceding questions and corresponding model answers) and a new query. In other embodiments, the user query 12 may include graphical elements or other information besides natural language text.

In this exemplary embodiment, the user query 12 is forwarded from the interface module 14 to a query processing module 18 for processing using a query chunking engine 19 and a query embedding engine 20 to break the textual user query 12 into discrete query chunks (represented by arrow 55) via query chunking engine 19, which may subsequently be embedded or transformed into a mathematical format via query embedding engine 20. In some embodiments, the query embedding engine 20 may transform the query chunks 55 produced by query chunking engine 19 into one or more query vectors (represented by arrow 21 in FIG. 1) each having a plurality of separate dimensions. As used herein, the term “engine” refers to a functionality implemented by a software executed on one or more computing devices, hardware processors, or specially-designed hardware (e.g., field-programmable gate array, application-specific integrated circuit). For example, a document chunking engine may comprise executable code or instructions that, when executed by a hardware processor, divides or segments data into separate, discrete chunks in a Q&A system.

The retrieval module 22, among other operations, is configured to receive the query vectors 21 from query processing module 18 and which are based on the original user query 12 received from the user 11. Particularly, a query analyzer 23 of retrieval module 22 receives the query vectors 21 and compares the query vectors 21 with selected source documents (represented by arrow 31 in FIG. 1) and/or specific contents thereof obtained from document processing module 32 and which are based on information obtained from document source 30 to generate an output prompt (represented by arrow 27 in FIG. 1).

In this exemplary embodiment, the query analyzer 23 of retrieval module 22 includes a scope identification engine 24 for identifying substantive content contained in the user query 12 indicative of the information that must be retrieved from document source 30 source documents 31 to provide an accurate and complete answer 52 to the user query 12. Particularly, scope identification engine 24 may leverage the generative model 40 to determine if the user query 12 is within scope for the Q&A system 10 as will be discussed further herein.

Following a determination of whether the user query 12 is within scope of the Q&A system 10, the query analyzer 23 may analyze the user query 12 to determine how best to answer the user query 12. As will be discussed further herein, in some embodiments, the query analyzer 23 devises a strategy for answering the user query 12 whereby selected documents 31 contained in document source 30 may be identified and extracted. In some embodiments, the query analyzer 23 defines one or more separate answer requirements that must be met by the answer 52 ultimately generated by the generative model 40 in order to satisfactorily respond to the user query 12. For instance, the answer requirements may identify specific selected documents 31 contained in document source 30 to be referenced in preparing the answer 52, specific sub-queries that must be answered as part of generating the larger or overall answer 52, and the like.

Additionally, in this exemplary embodiment, query analyzer 23 also includes a search engine 25 for executing a search of the document source 30 to identify or retrieve selected source documents 31 identified by the query analyzer 23 as being potentially relevant or responsive to the user query 12. Further, in this exemplary embodiment, query analyzer 23 includes a validation engine 26 for ensuring that the information contained or represented by selected source documents 31 is relevant and responsive to the user query 12. In some embodiments, validation engine 26 may compare selected information from document source 30 (via one or more document vectors obtained therefrom) with user query 12 to validate user query 12. For example, in some embodiments, validation engine 26 determines whether the selected source documents 31 meet each of the answer requirements determined by query analyzer 23 to ensure the answer 52 ultimately provided by Q&A system 10 is accurate and complete with respect to the given user query 12.

Consistent with the above, information obtained from document source 30 (e.g., one or more user-provided documents) is processed by document processing module 32 to convert natural language text and/or other information (e.g., graphical elements, and the like) contained in document source 30 into a mathematical format. Particularly, document processing module 32 includes a document chunking engine 50 configured to break the information contained in document source 30 into separate, discrete document chunks (indicated by arrow 56 in FIG. 1). Additionally, document processing module 32 includes a document embedding engine 34 configured to embed or transform the document chunks 56 into the document vectors 57 that may be selectively retrieved by retrieval module 22. In some embodiments, document processing module 32 may not include document embedding engine 34 and, instead, the document chunks 56 may be stored as plain text in database 33 or a separate data structure.

As previously described, in this exemplary embodiment, document chunking engine 50 is configured to break down or divide documents or data into smaller, manageable segments or document chunks 56 for more efficient processing and storage of the information contained in document source 30. In this instance, document embedding engine 34 converts documents obtained from document source 30 into the document vectors 57 that capture semantic context included in the source documents. As used herein, “embedding” refers to a piece of text projected into a higher-dimensional latent (numerical) space. In an embedding space ), similar chunks are positioned closer to each other than dissimilar items. In this manner, the similarity of a query to any document in document source 30 may be assessed or measured by retrieval module 22. The mathematical form of the chunked document(s) (document vectors 57) is indexed and stored in a database 33 (i.e., database 33 in this instance) prior to receiving user query 12 or dynamically. Although database 33 is shown as part of the document processing module 32 in FIG. 1, it may be understood that database 33 may instead comprise a stand alone component external of the document processing module 32 and with which the document processing module 32 interfaces. Additionally, in some embodiments, database 33 comprises a vector database. In other embodiments, database 33 comprises other types of databases for storing the chunked document(s) such as a SQL database and/or other data structures which, again, may be separate from the document processing module 32 itself.

The retrieval module 22 of Q&A system 10 may extract relevant chunks from selected documents 31, for example, by filtering, to provide the output prompt 27. Output prompt 27 may be relayed or forwarded from retrieval module 22 to the generative model 40 via the interface module 14. The output prompt 27 contains both the user query 12 and a query context (represented by numeral 35 in FIG. 1), which is provided to generative model 40. The query context 35 provided to generative model 40 corresponds to (e.g., contains and/or references) the information contained in the one or more selected source documents 31 identified by the retrieval module 22. As described above, generative model 40 is trained using a separate training dataset 13. For example, generative model 40 may be a pre-trained large language model (LLM). Generative model 40 generates a response 41 (e.g., in the form of generated natural language text) based on the output prompt 27 received thereby and which includes the query context 35. In some instances, the response 41 generated by generative model 40 may be outputted by Q&A system 10 as the answer 52 to user query.

In this exemplary embodiment, interface module 14 additionally includes a groundedness filter 16 that interrogates the response 41 received from the generative model 40 generated thereby based on the output prompt 27. In turn, groundedness filter 16, in response to receiving the generative response 41 from generative model 40, may subsequently provide a groundedness prompt 38 from generative model 40 to determine the groundedness of the response 41. For instance, the groundedness prompt 38 may instruct the generative model 40 to apply a groundedness score to the response 41 in view of the query context 35 contained in the output prompt 27. As used herein, the term “groundedness score” refers to the extent to which the response 41 is based on the selected documents contained in the output prompt 27 versus other information such as information obtained from training dataset 13.

As an example, the response 41 is grounded (having a high groundedness score) when it is wholly based on the query context 35 (e.g., contracts, agreements, and the like obtained from document source 30) and does not introduce new information that is not found in the query context 35. In some embodiments, the groundedness filter 16 applies a predefined groundedness threshold to the groundedness score produced by the generative model whereby if the groundedness score of the response 41 meets the groundedness threshold, the groundedness filter forwards the response as a selected response (represented by arrow 42 in FIG. 1) to the UI 15 for presenting to the user 11 as the answer 52. Conversely, if the groundedness score of the response 41 fails to meet the groundedness threshold, then a subsequent groundedness prompt 38 may be provided to the generative model 40 instructing the generative model 40 to generate a new and different response 41 that is more grounded on the query context 35 contained in the output prompt 27, for example, generative model 40 first explains how grounded response 41 is based on one or more predefined factors such as correctness, clarity, completeness, and brevity. This explanation then prompts a groundedness score for response 41. In this manner, the explanation informs the groundedness score that is assigned.

In a first example, when the groundedness score of the response 41 is 5 out of 5, the response 41 may be selected as the selected response 42 ultimately provided as the answer 52 to user query 12. In a second example, when the groundedness score is 4 out of 5 or lower, generative model 40 may be instructed by groundedness filter 16 (e.g., via a groundedness prompt 38) to subsequently generate a second response 41, which is evaluated by the groundedness filter 16 and the response generation process may continue until the groundedness score meets the groundedness threshold whereby the passing response 41 may be selected as the selected response 41 by groundedness filter 16 and provided to the user 11 as an answer 52 to user query 12.

In this manner, the answer 52 generated based on user query 12 does not rely generally on the training dataset 13 used to train generative model 40, and instead is forced by the groundedness filter 16 to provide an answer 52 that is satisfactorily based on specific data sources (i.e., selected documents 31 such as contracts) obtained from document source 30 to maximize the accuracy, coherency, and completeness of the answer 52 and thereby enhance the performance and efficiency of the Q&A system 10. In some embodiments, answer 52 may be formatted (e.g., converted to HTML) and returned to user 11 via the UI 15 of interface module 14. In some embodiments, several prompt engineering techniques including chain-of-thought prompting techniques, step-back prompting, few-short learning etc., may be utilized through the Q&A system 10 to synthesize information from multiple chunks to ensure that the answer 52 is aligned with the intent of user 11, as will be discussed further herein. It should be appreciated that the configuration of Q&A system 10 may vary from that shown in FIG. 1. For example, in some embodiments, Q&A system 10 may not include query embedding engine 20 and/or document embedding engine 34. In this instance, query chunks 55 and/or document chunks 56 may be processed and/or stored as plain text and/or in other suitable forms.

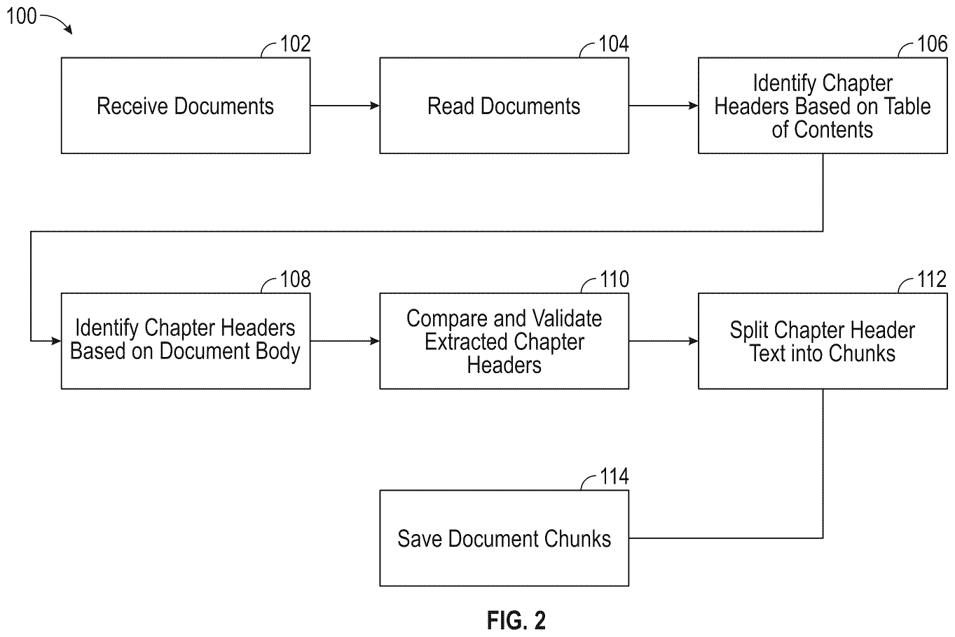

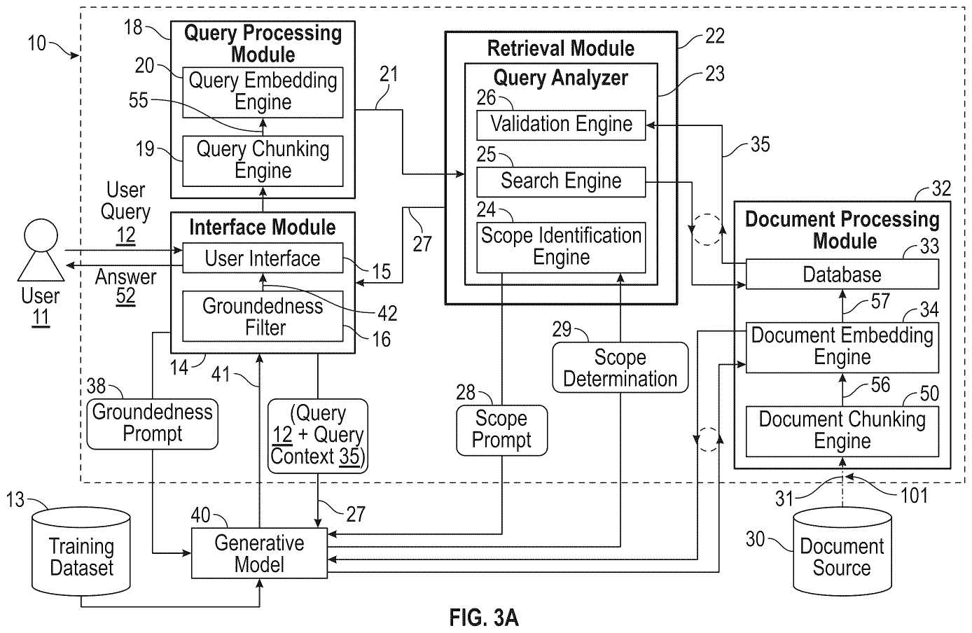

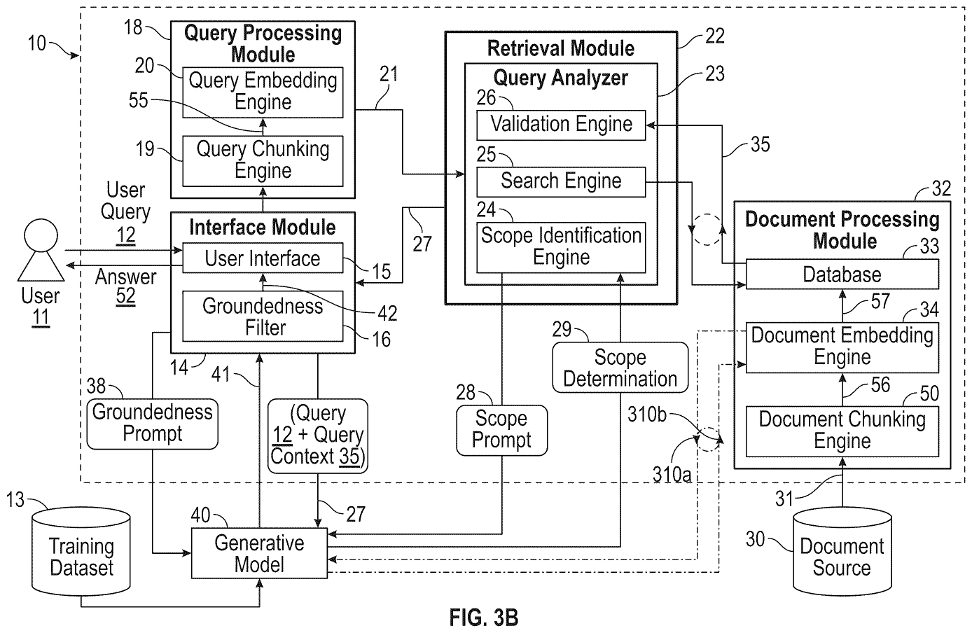

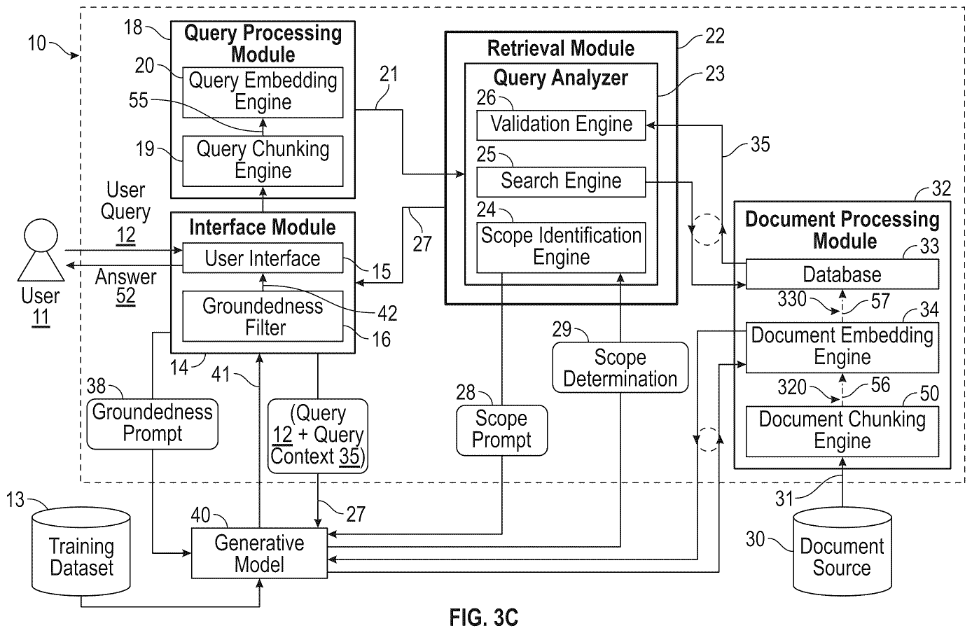

Referring now to FIGS. 2-3C, a flowchart of an exemplary embodiment of a document chunking method 100 that may be implemented by a document chunking engine in accordance with principles disclosed herein is shown in FIG. 2. Particularly, the document chunking engine 50 of FIG. 1 may be configured to implement method 100 in some embodiments. For instance, FIGS. 3A-3C of Q&A system 10 are provided to illustrate the features of method 100. However, in other embodiments, document chunking engine 50 may operate differently from the method 100 shown in FIG. 2. In addition, method 100 may be implemented or used to divide or chunk documents (e.g., documents 31 shown in FIG. 1) in systems that vary in configuration or function from the Q&A system 10 in FIG. 1.

As previously described, the chunking process involves breaking down data (e.g., natural language text) into smaller chunks or segments (e.g., of natural language text) for easier processing while retaining the semantic context contained in the original, unsegmented text. In this exemplary embodiment, method 100 begins at block 102 with receiving one or more documents (e.g., documents 31 of FIG. 1) provided, for example, by a user.

The one or more documents are received from a document source. As an example, arrow 101 of FIG. 3A illustrates one or more source documents 31 being received by document processing module 32 from document source 30. The document source may include one or more document repositories or databases comprising, for example, organization/domain specific data such as contracts or other legal documents. The documents contained in the document source may be provided by a user as part of inputting a query (e.g., user query 12 shown in FIG. 1) to a Q&A system.

At block 104, the document is read or ingested such as by a document chunking engine such as, for example, document chunking engine 50. The document may be read to extract selected information therefrom including text, images, metadata, and other elements. For instance, the document may be read at block 104 to identify natural breaks (e.g., sections, headers or paragraphs) as well as other formatting elements in the document in order to parse or extract one or more relevant features for chunking the given document including, for example, a ToC of the document, section headers, sub-headers, section breaks, indentation and so on. In some embodiments, the documents may be read and formatted using a Python library such as, for example, Python PDF (PyPDF).

At block 106, chapter headers are identified (e.g., read and extracted) in the document based on the identified ToC of the document. For example, headers from the ToC may be identified by searching for numbered or bulleted lists near the beginning of the document that contain page numbers. In some embodiments, machine learning (ML) or artificial intelligence (AI) models may be leveraged in identifying such features contained in the document. As an example, arrows 310a and 310b of FIG. 3B represent an iterative loop formed between document chunking engine 50 and generative model for implementing one or more steps of method 100 including, for instance, block 106. Particularly, in this example, document chunking engine 50 may utilize generative model 40 in identifying the chapter headers contained in the ToC of the document. Alternatively, document chunking engine 50 itself may identify the chapter headers from the ToC of the document at block 106.

At block 108, method 100 includes identifying (e.g., reading and extracting) chapter headers in the document based on the document body. For example, a start or beginning page of a document that is usually found directly following the ToC or title page may be used to identify the body of the document. In this manner, method 100 may divide the document into a ToC and a body that is separate from the ToC. Unlike block 106 of method 100 which seeks to identify the chapter headers of the document from the ToC thereof, block 108 includes separately identifying the chapter headers using only the body of the document and not the ToC thereof. Thus, in at least some instances, the chapter headers identified at block 108 may vary from the chapter headers identified at block 106. To provide an example, document chunking engine 50 may be utilized to identify chapter headers in source documents 31 obtained from document source 30. For instance, document chunking engine 50 may, in some embodiments, iteratively prompt the generative model 40 to leverage the generative model 40 in identifying chapter headers from the body of the selected source document 31 as indicated by arrows 310a and 310b in FIG. 3B. In this manner, document chunking engine 50 may prompt the generative model 40 to read through the full text of the document (if the content window size of the generative model 40 permits) to explain and then identify how the chapter headers are represented/formatted. The document chunking engine 50 may prompt the generative model 40, for instance, to explain how chapter headers look in the document and how to identify them. The document chunking engine 50 may then chunk the document into arbitrarily small chunks and prompt the generative model 40 to determine for each chunk whether a chapter header is present therein using the information identified above.

Method 100 continues at block 110 with comparing or correlating the chapter headers identified from the ToC of the document with the chapter headers identified from the body of the document. In some embodiments, the chunking engine may perform content matching to ensure the chapter headers identified from the body of the document match the chapter headers identified from the TOC by determining, for instance, if the text of the chapter headers are identical or sufficiently similar. By comparing the chapter headers identified from the ToC with chapter headers identified from the document body, the chunking engine can validate the accuracy of the chapter headers identified from the document, and identify potential errors or inconsistencies, thereby ensuring accuracy of the answer or response that will be provided later. In some embodiments, chapter headers identified in the ToC or the body of the document may not match a corresponding body/ToC chapter header. In this instance, a union of the multiple sets of chapter headers may be used at block 110 to produce a plurality of validated chapter headers used to chunk the document. In an example, the document chunking engine 50 may implement block 110 by comparing chapter headers identified in a ToC of a selected source document 31 with chapter headers identified in a body thereof to provide a plurality of validated chapter headers of the source document 31.

Once validated at block 110, method 100 continues at block 112 where the document is divided into separate chunks (e.g., natural language or textual chunks) by headers. In some embodiments, block 112 may be implemented using a pattern matching or text manipulation algorithm (e.g., the regular expression or Regex algorithm) whereby the text of the chapter headers may be split. In this manner, the validated chapter headers may be applied to the pattern matching algorithm which may be used to identify and extract the chapters or other segments of data that correspond to the given chapter header.

As previously disclosed, prompts 310a may be provided to the generative model 40 by the document chunking engine 50 whereby corresponding responses 310b are generated by the generative model 40 and received by the document chunking engine 50 to facilitate the chunking of selected documents 31 obtained from document source 30. In an example, document chunking engine 50 may send a prompt to generative model 40 to process information contained in the selected source document 31.

At block 114, the plurality of chunks is stored or saved in a database for later retrieval. In some embodiments the plurality of chunks is embedded and then saved in a database (e.g., database 33 of FIG. 1). In some embodiments, the extracted chapters are indexed with their corresponding chapter headers when the chunks are stored as part of an index or other data structure. For instance, the chapter headers and their corresponding chapters may be stored as key/value pairs with the chapter headers representing the “keys” and the corresponding chapters representing the “values” of the key/value pairs.

Following the storage of the separate chunks of the selected document, the chunks may be transformed or embedded into numerical vectors and stored in a corresponding data structure such as, for example, a database for later access by components of a Q&A system. As an example, the plurality of document chunks (indicated by arrow 320 in 3C) produced by document chunking engine 50 (e.g., via implementing method 100) may be transferred to a document embedding engine 34 for further processing (indicated by arrow 330 in FIG. 3C). As previously described, the conversion of chunks of natural language text into a mathematical format is called embedding where the chunks of text are converted or encoded in a mathematical format that a computing system (e.g., executing Q&A system 10) can read, understand, and process.

In some embodiments, embedding algorithms of document embedding engine 34 may convert the document chunks 320 into document vectors 330 each corresponding to a separate mathematical object having a plurality of separate magnitudes with respect to a plurality of corresponding dimensions. The values of these document vectors 330 retain important details about the meaning, context, semantic, and syntactic properties of the document 101. In this manner, the document vectors representing the document chunks are saved in the database 33 in this example as indicated by arrow 330 in FIG. 3C.

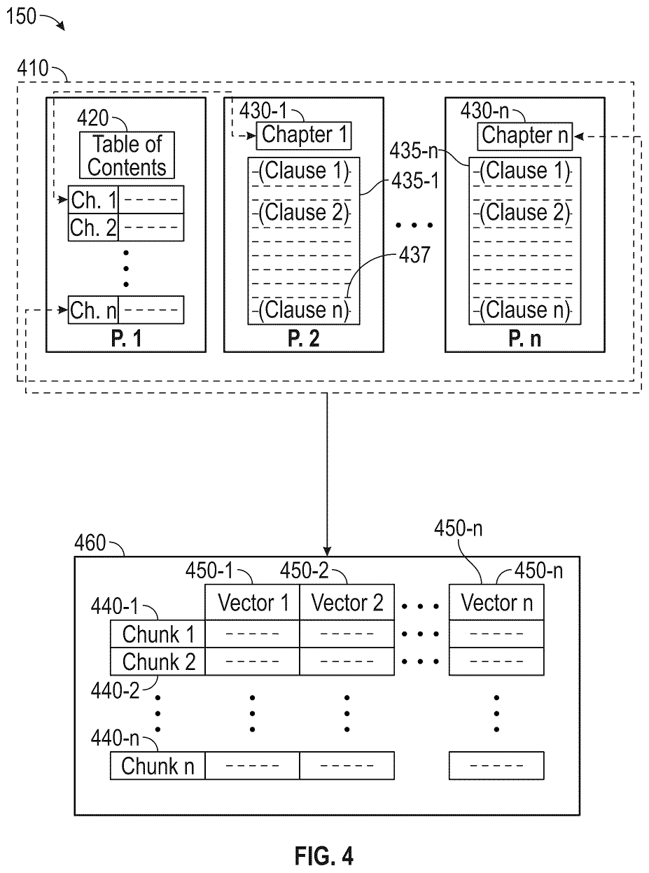

Referring to FIG. 4, an exemplary schematic diagram illustrating processes undertaken by the document chunking engine 50 and document embedding engine 34 of FIG. 1 in accordance with principles disclosed herein is shown. In this exemplary embodiment, the retrieved document 410 (similar to selected source document 31 in FIG. 1) includes a ToC 420 with n extracted chapter headers 430 (shown as chapter headers 430-1 through 430-n in FIG. 4) each associated with a corresponding n chapters 435 (shown as chapters 435-1 through 435-n in FIG. 4) containing one or more clauses 437. Document 410 is chunked (e.g., by document chunking engine 50 of FIG. 1) using the ToC 420 and chapter headers 430 into for example, a plurality of separate chunks 440 (shown as chunks 440-1 through 440-n in FIG. 4).

Particularly, in some embodiments, document 410 is chunked based on the chapter headers 430 the document chunking engine 50 has successfully validated by the ToC 420. For instance, chunks 440 may comprise different chapters 435 of the document 410 (e.g., a first chunk 440-1 contains a first validated chapter 435-1, and so on and so forth). Alternatively, the chapters 435 of document 410 may be further broken down or chunked into groups (or singular) clauses 437 contained therein (e.g., a first chunk 440-1 may contain a first portion (e.g., one or more first clauses 437) of a first validated chapter 435-1 while a second chunk 440-2 may include a second portion (e.g., one or more other clauses 437) of the first validated chapter 435-1) depending on the token size limit of the generative model (e.g., generative model 40 shown in FIG. 1) used by the given document chunking engine 50.

Each chunk 440 is then converted into a plurality of vectors (n-dimensional vectors) 450 (shown as vectors 450-1 through 450-n in FIG. 4) by document embedding engine 34 and stored in a database 460 (similar to database 33 of FIG. 1). The document embedding engine 34 may transform chunks 440 into numerical vectors using embedding techniques such as sentence-BERT, Universal sentence encoder, and so on. In some embodiments, neural networks (e.g., deep learning techniques) may be used to transform chunks 440 into vectors. Additionally, in some embodiments, chunks 440 may not be embedded as vectors and instead may be stored and retrieved as plain text.

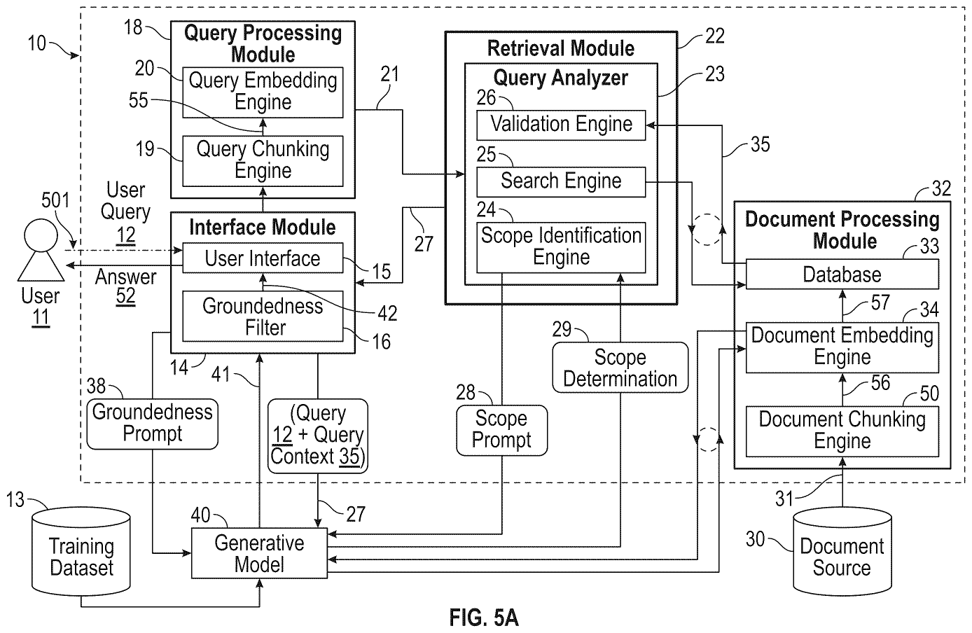

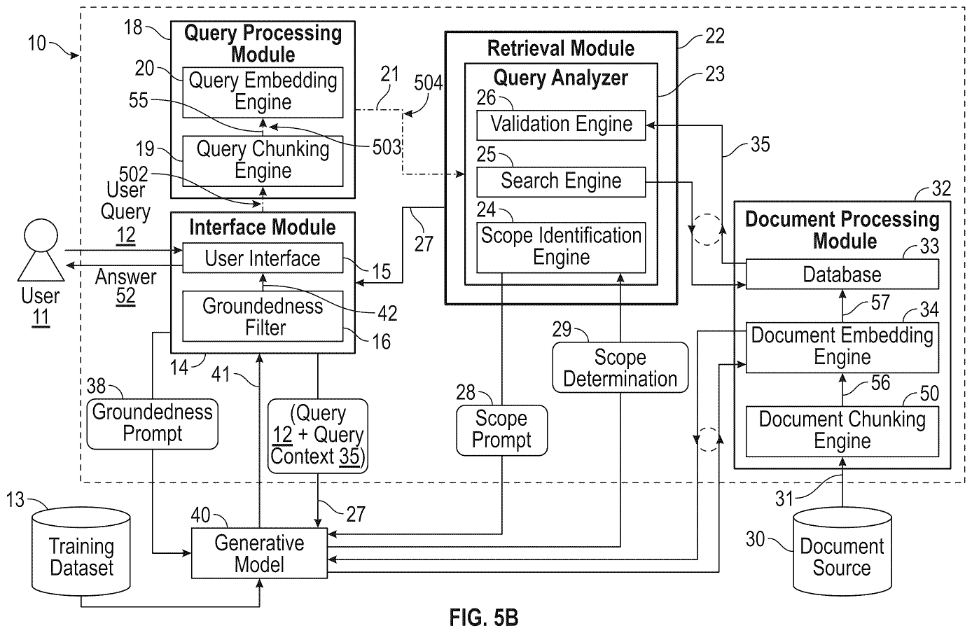

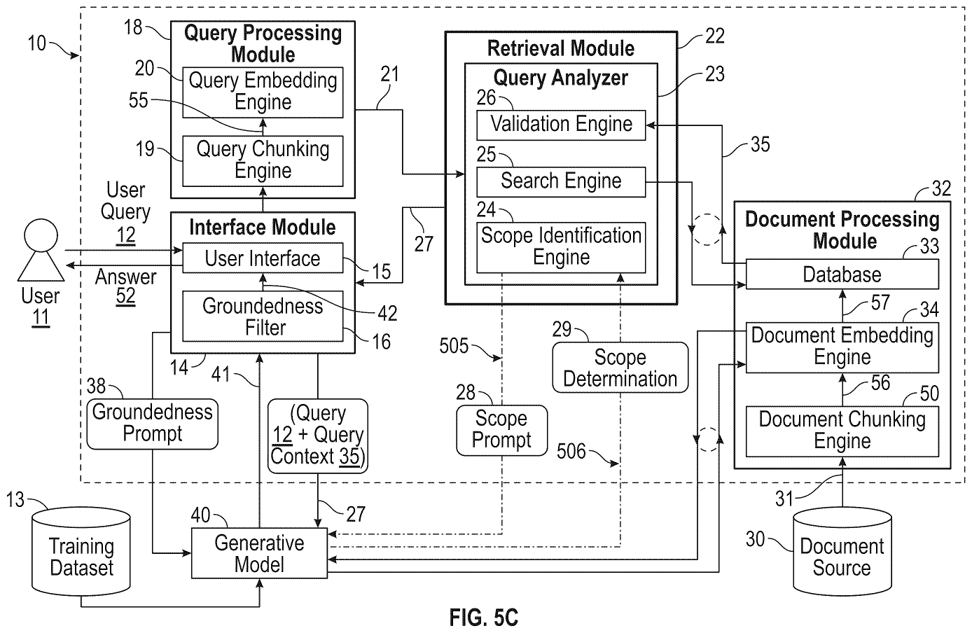

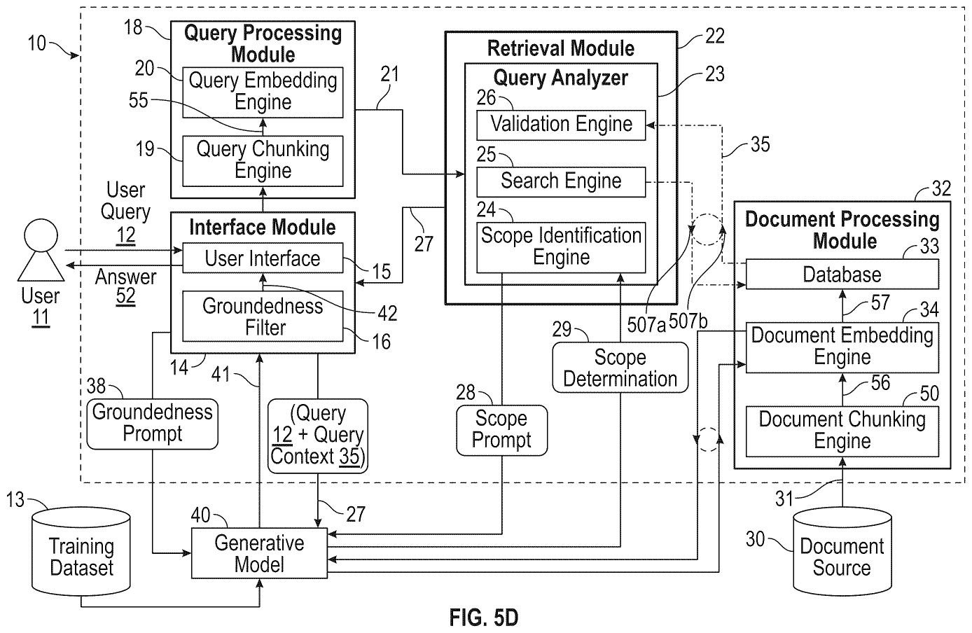

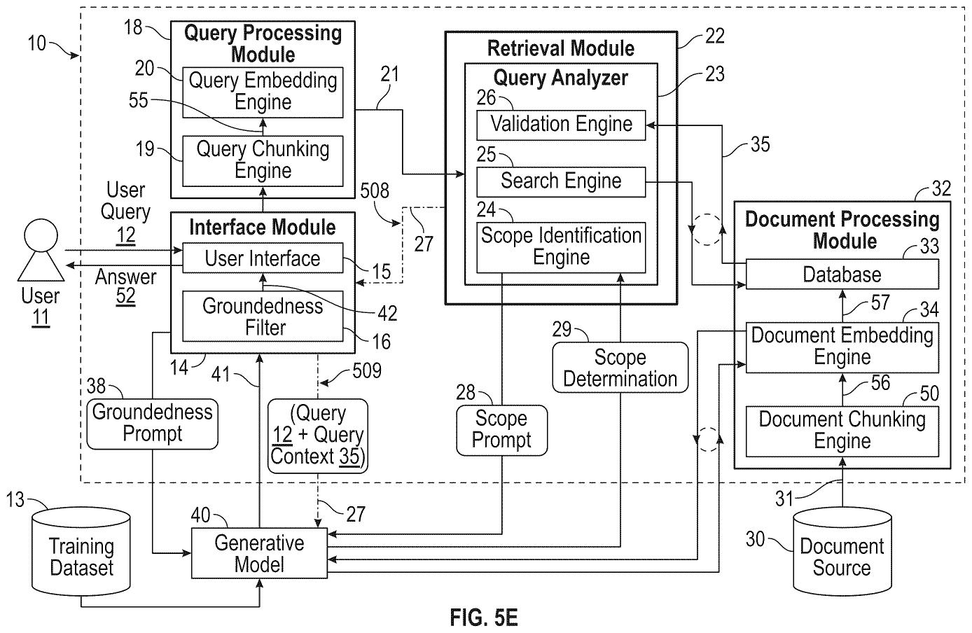

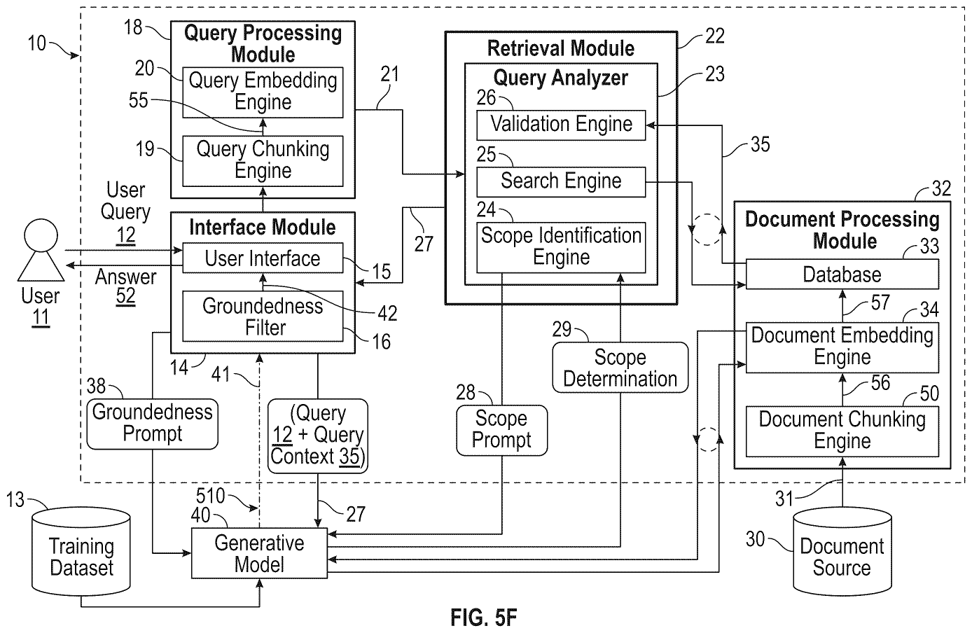

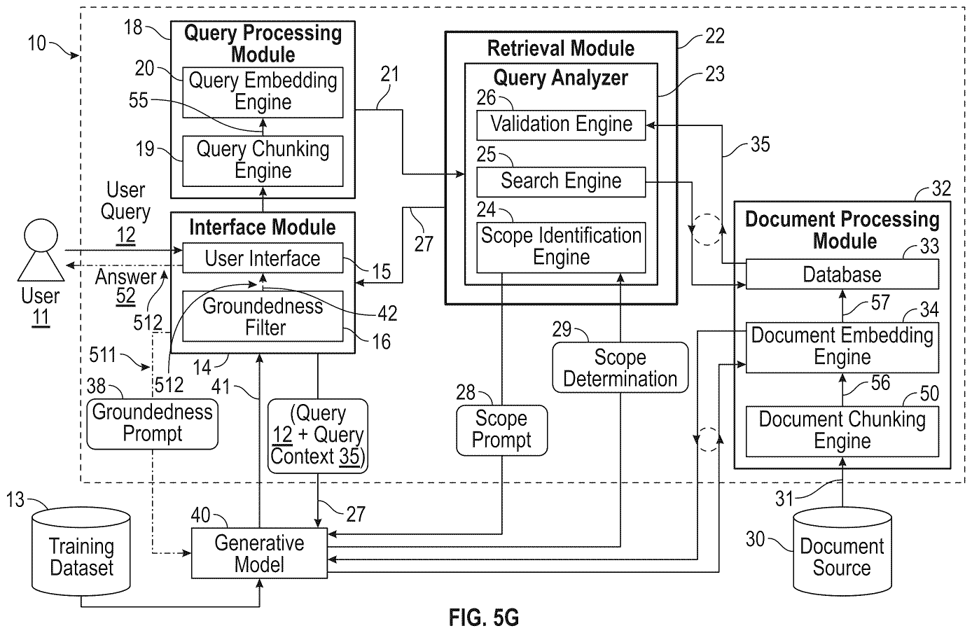

Referring now to FIGS. 5A-5G, block diagrams illustrating exemplary processes implemented or executed by the Q&A system 10 of FIG. 1 is shown. The process steps shown in FIGS. 5A-5G are only exemplary and, in some embodiments, Q&A system 10 may operate differently from the processes shown in FIGS. 5A-5G. In addition, the processes illustrated in FIGS. 5A-5G may be implemented or used in systems that vary in configuration or function from Q&A system 10 in FIG. 1.

As illustrated in FIG. 5A, a user 11 may input a user query 12 (indicated by arrow 501) via the interface module 14 of Q&A system 10. In this manner, interface module 14 serves as the interface or connection point between user 11 and other components of Q&A system 10. As previously described, the user query 12 may be a question in the form of, for example, natural language or text received via the UI 15 of the interface module 14 of Q&A system 10, a conversation (i.e., multiple preceding questions and corresponding model answers) and the new query. The user query 12 may be based on a keyword, a phrase or any other alphanumeric entry inputted into UI 15. For example, UI 15 may include a text input field into which user 11 may input a user query 12. The text input field may include helpful features, such as, auto-suggestions, predefined categories, or keywords that enhance overall user experience and streamline the Q&A process. In some embodiments, the user query 12 may include graphical elements or other information besides natural language text. In certain embodiments, user query 12 may be a single question from which an associated answer can be determined or multiple questions.

In some embodiments, interface module 14 may pre-process and validate user query 12, to ensure user query 12 meets the necessary format or criteria before it is forwarded to the query processing module 18 for processing. For example, interface module 14 may perform a format check to ensure user query 12 contains only valid characters (e.g., no special characters or symbols). However, in some embodiments, mathematical formulas, including latex may be allowed. Further, the user query 12 may reference one or more source documents 31 previously provided to the Q&A system 10 and which has already been chunked by document chunking engine 50 and stored as a set of vectors in the database 33. For instance, the user query 12 may include one or more queries pertaining to one or more corresponding source documents 31 such as, for example, if any of the source documents 31 contain information regarding a topic specified by the user query 12.

As shown particularly in FIG. 5B, once received and processed by the interface module 14, the user query 12 is forwarded from interface module 14 to query processing module 18 as indicated by arrow 502 in FIG. 5B. The query processing module 18 transforms the received (e.g., alphanumeric, graphical, and the like) user query 12 into a set of mathematical vectors that the Q&A system 10 can effectively use to retrieve or generate an answer using the generative model 40. In some embodiments, query processing module 18 may employ natural language processing techniques to analyze, identify key elements, named entities, and important keywords in the user query 12.

As previously described, query processing module 18 processes user query 12 using query chunking engine 19 and query embedding engine 20. In some embodiments, the query chunking engine 19 breaks user query 12 into one or more separate query chunks 55 (indicated by arrow 503 in FIG. 5B) that are subsequently embedded or transformed into a mathematical format (e.g., one or more corresponding query vectors 21) by query embedding engine 20. In some embodiments, query chunking engine 19 may divide user query 12 into individual words or phrases so as to capture the semantic context of the user query 12 within the different query chunks 55. In some embodiments, query embedding engine 20 may transform the query chunks 503 generated by query chunking engine 19 into one or more query vectors 21, with each query vector 21 having multiple separate dimensions. Once embedded as one or more query vectors 21, the embedded query vectors 21 are then forwarded from query processing module 18 to the query analyzer 23 (indicated by arrow 504 in FIG. 5B) of retrieval module 22. In other embodiments, user query 12 is processed and key information extracted without transforming and/or embedding query chunks 503 which instead may be stored and retrieved as plain text. Thus, in some embodiments, query processing module 18 may not include query embedding engine 20.

The scope identification engine 24, search engine 25, and validation engine 26 of query analyzer 23 work together to interpret user query 12 and identify a substantive scope of the user query 12 to, for instance, ensure the user query 12 is within a predefined substantive scope (or simply “within scope”) of the Q&A system 10. For instance, the Q&A system 10 may be configured to answer only particular types of questions regarding predefined subject matter or topics such that it may be desired by a provider or operator of Q&A system 10 to restrict the Q&A system 10 from answering user queries 12 that fall outside of the substantive scope of Q&A system 10. As an example, any user query 12 that relies on the information in document source 30 may be classified as within scope, whereas any user query 12 that can be answered without having access to the document source 30 maybe classified as out of scope. By ensuring Q&A system only provides responses to user queries 12 that fall within the substantive scope of Q&A system 10, the scope identification engine 24 may prevent Q&A system 10 from providing inaccurate information to users 11 and/or to prevent users 11 from using Q&A system 10 in ways that are not desired by the provider of Q&A system 10.

Particularly, in this exemplary embodiment, scope identification engine 24 leverages the generative model 40 to analyzes user query 12 to determine which source documents 31 are referenced or otherwise relevant to the user query 12, and identify the relevant substantive information that must be obtained (what is the substantive question being asked by the user query 12?) in order to completely and accurately answer the user query 12.

For example, scope identification engine 24 may provide a scope prompt 28 to generative model 40 requesting the generative model 40 to determine whether or not the user query 12 is within scope. In some embodiments, the scope prompt 28 requests the generative model 40 to both initially provide an explanation as to whether the user query 12 the substantive information required to completely and accurately answer the user query 12, as indicated by arrow 505 in FIG. 5C. In response to receiving the scope prompt 28, generative model 40 generates a scope determination 29 responsive to scope prompt 28 and which is forwarded to scope identification engine 24 (indicated by arrow 506 in FIG. 5C). In some embodiments, scope prompt 28 may comprise user query 12 and instructions on how to formulate a response/answer. Scope prompt 28 (and other prompts discussed herein) may follow from a predefined template and may include, for example, a prompt skeleton, a system message, instructions, examples, data source information, and additional inputs such as the user query 12.

In certain embodiments, the scope prompt 28, in addition to requesting the generative model 40 to provide an explanation as to whether the user query 12 is within scope, also requests the generative model 40 to determine, based on the previously generated explanation, whether the user query 12 falls within the substantive scope of the Q&A system 10. In this manner, scope prompt 28 may leverage an “explain-then decide” prompting strategy to break the task of determining whether the user request 12 is within scope into simpler subtasks that may be more effectively (e.g., quickly, accurately) accomplished by the generative model 40 than simply providing a single request in the scope prompt 28 for the generative model 40 to determine if the user query 12 is within scope. As described herein, explain-then-decide prompting strategies may be employed by Q&A system 10 whenever it is convenient or advantageous to break down complex tasks into smaller subtasks that may be solved by the generative model 40 sequentially.

In some embodiments, generative model 40 generates a scope determination 29 in response to receiving the scope prompt 28. In this manner, scope identification engine 24 determines whether the user query 12 is within scope, following which the query analyzer 23 (in instances in which the user query 12 is within scope) identifies which source documents 31 (and/or which specific information contained in identified source documents 31) must be obtained by the retrieval module 22 in order to completely and accurately answer the user query 12. Conversely, should the scope determination 29 indicate that the user query 12 is not within scope, the interface module 14 may provide a notification (e.g., via UI 15) to the user 11 that the user query 12 is not within scope and thus cannot be answered by the Q&A system 10.

The query analyzer 23, after determining that the user query 12 is within scope, may analyze the user query 12 to determine which specific source documents 31 are referred to (e.g., which legal contracts, engineering documents) in the user query 12. In this manner, query analyzer 23 may identify which source documents 31 are most relevant to the user query 12 to ensure that the Q&A system 10 focuses on retrieving information that directly address user query 12. For example, the query analyzer 23 may identify specific source documents 31 from document source 30 to be referenced in preparing the answer 52, particular sub-queries that need to be answered as part of generating the answer 52, and so forth. The source documents 31 identified by query analyzer 23 as relevant to answering the user query 12 may be referred to explicitly or implicitly (e.g., identifiable through the semantic context of the user query 12) in the user query 12.

In certain embodiments, the query analyzer 23 generates a document identification strategy for identifying which source documents 31 are needed to completely and accurately answer the user query. For instance, the query analyzer 23 may break the user query 12 down into one or more specific answer requirements that must be met in order to satisfactorily answer the user query 12. In this manner, the query analyzer 23 may parameterize the user query 12 in order to ensure the user query 12 is completely answered by the Q&A system 10. For example, if the user query 12 relates to a legal document from 2024 involving a specific counterparty, the retrieval strategy may be to search for documents that contain relevant keywords within a subset of documents, and filtering the documents using 2024 as the year and the specified counterparty as the counterparty.

In this exemplary embodiment, the query analyzer 23 leverages the search engine 25 and validation engine 26 and/or other components of Q&A system 10 and/or generative model 40 to ensure that the Q&A system 10 retrieves only the most pertinent information. As previously described, search engine 25 is configured to execute a search of the source documents 31 of document source 30 (e.g., following their embedding into database 33) to identify or retrieve one or more source documents 31 (or selected contents thereof) as being potentially relevant or responsive to user query 12. For instance, once the query analyzer 23 analyzes the user query 12 to define its context and intent, it identifies key concepts, topics, and relevant documents needed for generating a response or search result.

For instance, and as illustrated in FIG. 5D, document queries 507a are made iteratively to the database 33 by the search engine 25 whereby corresponding search results 507b are received by the validation engine 26 from the database 33 to validate the relevance of the received information. Although validation engine 26 is shown in FIG. 5D as receiving the retrieved information or search result 507b from database 33, alternatively, the document queries 507a may be provided to the document source 30 (or other data store) with the search result 507b obtained directly from document source 30.

In some embodiments, search engine 25 may leverage techniques such as keyword matching, semantic search, and ranking algorithms to retrieve pertinent data and documents that align with the previously determined answer requirements. The validation engine 26 of query analyzer 23 determines whether the search result 507b meet each of the answer requirements determined by query analyzer 23. As previously described, validation engine 26 may compare the search result 507b with user query 12 to validate that the information referenced by or contained in the search result 507b is sufficient to satisfactorily answer the user query 12. For example, validation engine 26 may compare source documents 31 in a mathematical form (i.e., document content vectors 57) that were previously indexed and stored in database 33 or created dynamically with the user query 12. In this manner, validation engine 26 functions as a gatekeeper ensuring that the contents of the search result 507b (e.g., the contents of the identified as relevant source documents 31) aligns with the user query 12 based on the answer requirements of the user query 12. For example, validation engine 26 may check for consistency with the identified scope of the information referenced by or contained in search result 507b by ensuring that the contents of the search result 507b contain the required relevant information. In other embodiments, validation engine 26 may also rank the identified as relevant source documents 31 based on relevance, specific sources etc., filtering out any irrelevant information.

In certain embodiments, should the query analyzer 23 determine that the search result 507b fails to address each of the answer requirements of the user query 12, an updated document query 507a is made configured to identify additional contents of source documents 31 specifically addressing the missing answer requirements. This process may be performed several or numerous times until a final search result 507b is received that references or contains information (e.g., identified source documents 31 and/or specific contents of identified source documents 31) sufficient to address each of the answer requirements of the user query 12.

Once a final search result 507b is validated by the validation engine 26 as identifying information to satisfactorily answer the user query 12 (e.g., by addressing each of the determined answer requirements), retrieval module 22 generates an output prompt 27 (indicated by arrow 508 in FIG. 5E), which is relayed or forwarded to the generative model 40 via, in this exemplary embodiment, the interface module 14 as indicated by arrow 509 in FIG. 5E. The output prompt 27 contains both the user query 12 and query context 35 determined by retrieval module 22 from the final search result 507b, each which is provided to generative model 40.

As illustrated in FIG. 5F, generative model 40 generates a response 41 (indicated by arrow 510 in FIG. 5F) based on the user query 12 and query context 35. Consistent with the above, the query context 35 may include source documents 31 (and/or selected contents thereof) identified by the final search result 507b received by retrieval module 22 and determined by retrieval module 22 as sufficient for addressing each of the answer requirements of the user query 12. The generative model 40 integrates and the query context 35 with the user query 12 to construct response 41. As previously described, the Q&A system 10 may utilize several prompt-engineering techniques throughout the Q&A system 10. For example, the interface module 14 may request the generative model 40, when generating response 41, to determine if all (or at least how much) of the substantive content or information contained in response 41 included in the query context 35. By utilizing the user query 12 along with the query context 35, generative model 40 is able to generate informed, more accurate, context-aware responses to user queries.

In some embodiments, the groundedness filter 16 of the interface module 14 issues a groundedness prompt 38 to generative model 40, requesting an interrogation of the response 41 as indicated by arrow 511 in FIG. 5G. For example, groundedness prompt 38 may instruct the generative model 40 to determine a groundedness score of the response 41 in view of the query context 35 contained in the output prompt 27 prior to issuing answer 52 to user 11. In some embodiments, the groundedness prompt 38 leverages explain-then decide prompting strategies by first instructing the generative model 40 to first evaluate and explain if all (or how much of) of the substantive content of the response 41 is included in the query context 35 whereby the generative model 40 produces a groundedness explanation. Additionally, the groundedness prompt 38 may further instruct the generative model 40 to determine the groundedness score of the response 41 based on the groundedness explanation previously generated by the generative model 40.

For instance, groundedness filter 16 may apply a predefined groundedness threshold to the groundedness score determined by the generative model whereby, if the groundedness score of the response 41 meets the groundedness threshold, the groundedness filter forwards the response 41 as the selected response 42 (represented by arrows 512 in FIG. 5G) to the UI 15 for presenting to the user 11 as the answer 52. Conversely, when the groundedness score of the response 41 fails to meet the groundedness threshold, a subsequent groundedness prompt 38 may be iteratively provided to generative model 40 instructing the generative model 40 to generate a new and different response 41 that is more grounded on the query context 35 contained in the output prompt 27. In this manner, the response 41 undergoes a separate validation check to ensure that answer 52 meets the required standard and accurately reflects the information in the query context 35 and user query 12.

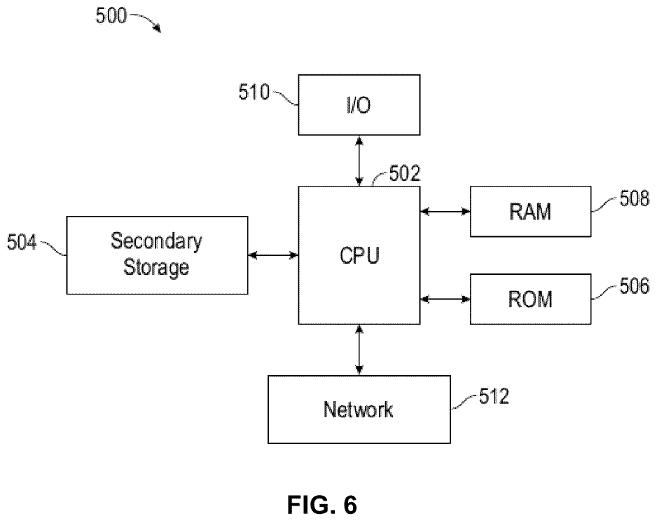

Referring now to FIG. 6, a computer system 500 suitable for implementing one or more embodiments disclosed herein is shown. Any of the systems and methods disclosed herein can be carried out (e.g., entirely or partially) on a computer or other device comprising a processor (e.g., a desktop computer, a laptop computer, a tablet, a server, a smartphone, or some combination thereof). The computer system 500 includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor 502 may be implemented as one or more CPU chips.

It is understood that by programming and/or loading executable instructions onto the computer system 500, at least one of the CPUs 502, the RAM 508, and the ROM 506 are changed, transforming the computer system 500 in part into a particular machine or apparatus having the novel functionality taught by the present disclosure. Thus, the RAM 508 and/or the ROM 506 may comprise a non-transitory machine-readable (or computer-readable) medium that may include instructions (which may be referred to herein as machine-readable instructions) that are executable by CPU 502 to provide functionality to computer system 500. Thus, in some embodiments, a machine-readable instructions stored on a memory may be executed on a processor, so as to configured the processor to carry out some or all of the features of the methods described herein (e.g., method 500).

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware (for example in an application specific integrated circuit (ASIC), or field-programmable gate arrays (FPGA)) because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 500 is turned on or booted, the CPU 502 may execute a computer program or application. For example, the CPU 502 may execute software or firmware stored in the ROM 506 or stored in the RAM 508. In some cases, on boot and/or when the application is initiated, the CPU 502 may copy the application or portions of the application from the secondary storage 504 to the RAM 508 or to memory space within the CPU 502 itself, and the CPU 502 may then execute instructions of which the application is comprised. In some cases, the CPU 502 may copy the application or portions of the application from memory accessed via the network connectivity devices 512 or via the I/O devices 510 to the RAM 508 or to memory space within the CPU 502, and the CPU 502 may then execute instructions of which the application is comprised. During execution, an application may load instructions into the CPU 502, for example load some of the instructions of the application into a cache of the CPU 502. In some contexts, an application that is executed may be said to configure the CPU 502 to do something, e.g., to configure the CPU 502 to perform the function or functions promoted by the subject application. When the CPU 502 is configured in this way by the application, the CPU 502 becomes a specific purpose computer or a specific purpose machine.

The secondary storage 504 is typically comprised of one or more disk drives or tape drives and is used for non-volatile storage of data and as an over-flow data storage device if RAM 508 is not large enough to hold all working data. Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The RAM 508 is used to store volatile data and perhaps to store instructions. Access to both ROM 506 and RAM 508 is typically faster than secondary storage 504. The secondary storage 504, the RAM 508, and/or the ROM 506 may be referred to in some contexts as computer readable storage media and/or non-transitory computer readable media.

I/O devices 510 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 512 may take the form of modems, modem banks, Ethernet cards, Omni-Path Architecture (OPA), InfiniBand (IB), universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 512 may enable the processor 502 to communicate with the Internet or one or more intranets. With such a network connection, it is contemplated that the processor 502 might receive information from the network, or might output information to the network (e.g., to an event database) in the course of performing the methods described herein. Such information, which is often represented as a sequence of instructions to be executed using processor 502, may be received from and outputted to the network, for example, in the form of a computer data signal embodied in a carrier wave.

Such information, which may include data or instructions to be executed using processor 502 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 502 executes instructions, codes, computer programs, scripts which it accesses from hard disk, floppy disk, optical disk, solid state drives (SSD) (these various disk-based systems may all be considered secondary storage 504), flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In an embodiment, the computer system 500 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 500 to provide the functionality of a number of servers that is not directly bound to the number of computers in the computer system 500. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 500, at least portions of the contents of the computer program product to the secondary storage 504, to the ROM 506, to the RAM 508, and/or to other non-volatile memory and volatile memory of the computer system 500. The processor 502 may process the executable instructions and/or data structures in part by directly accessing the computer program product, for example by reading from a CD-ROM disk inserted into a disk drive peripheral of the computer system 500. Alternatively, the processor 502 may process the executable instructions and/or data structures by remotely accessing the computer program product, for example by downloading the executable instructions and/or data structures from a remote server through the network connectivity devices 512. The computer program product may comprise instructions that promote the loading and/or copying of data, data structures, files, and/or executable instructions to the secondary storage 504, to the ROM 506, to the RAM 508, and/or to other non-volatile memory and volatile memory of the computer system 500.

In some contexts, the secondary storage 504, the ROM 506, and the RAM 508 may be referred to as a non-transitory computer readable medium or a computer readable storage media. A dynamic RAM embodiment of the RAM 508, likewise, may be referred to as a non-transitory computer readable medium in that while the dynamic RAM receives electrical power and is operated in accordance with its design, for example during a period of time during which the computer system 500 is turned on and operational, the dynamic RAM stores information that is written to it. Similarly, the processor 502 may comprise an internal RAM, an internal ROM, a cache memory, and/or other internal non-transitory storage blocks, sections, or components that may be referred to in some contexts as non-transitory computer readable media or computer readable storage media. At least some, if not all, of the steps or “blocks” of methods shown in FIGS. 1 through 5 may be executed by the computer system 500 shown in FIG. 6, although it is to be understood that at least some of the steps of methods disclosed herein may be executed by systems other than computer system 500.

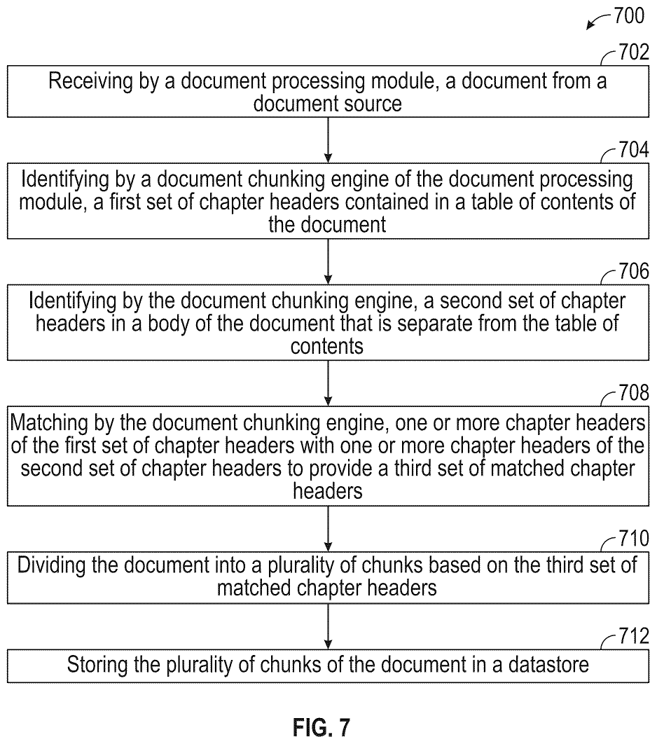

Referring now to FIG. 7 an embodiment of a computer-implemented method 700 for answering queries is shown. At least some, if not all, of the steps or “blocks” of method 700 shown in FIG. 7 may be executed by the computer system 500 shown in FIG. 6, although it is to be understood that at least some of the steps of method 700 may be executed by systems other than computer system 500. Additionally, it may be understood that the generation of answers described by method 700 may be used for a variety of purposes, including information retrieval and in business/customer support applications. Particularly, and as further discussed below, method 700 may incorporate at least some of the features or steps of Q&A system 10/method 100 described above and shown in FIGS. 1 and 2.

Beginning at block 702 method 100 includes receiving by a document processing module a document from a document source. As previously described, the document source may include one or more document repositories or databases coupled to computer system 500 and comprising, for example, organization/domain specific data such as contracts or other legal documents. The documents received from the document source may be provided by a user as part of inputting a query into a user interface of a Q&A system.

Method 700 continues at block 704 with identifying by a document chunking engine of the document processing module, a first set of chapter headers contained in a ToC of the document. As previously described, the document received is read to identify a ToC of the document from which a first set of chapter headers are extracted. For example, the document chunking engine may identify the first set of chapter headers by searching for numbered or bulleted lists near the beginning of the document that contain page numbers, indentation and so on, or by leveraging machine learning or artificial intelligence models.

At block 706, method 700 continues with identifying by the document chunking engine, a second set of chapter headers in a body of the document that is separate from the ToC. As previously described, the document engine may identify the document body, for example, by a start or beginning page of the document right after the ToC or title page, and identify a second set of chapter headers within the identified document body. In this manner, the second set of chapter headers is separately identified from the document body.

Method 700 continues at block 708 with matching by the document chunking engine, one or more chapter headers of the first set of chapter headers with one or more chapter headers of the second set of chapter headers to provide a third set of matched chapter headers. As previously described, the document chunking engine may compare or correlate the first set of chapter headers identified from the ToC of the document with the second set of chapter headers identified from the document body. In some embodiments, the document chunking engine may perform content matching to ensure the second set of chapter headers identified form the document body match the first set of chapter headers identified from the ToC by determining, for example, if the texts of the first and second sets of chapter headers are identical or sufficiently similar. In some embodiments, chapter headers identified in the ToC and document body that do not match are discarded, while matched chapter headers are provided as the third set of matched chapter headers.

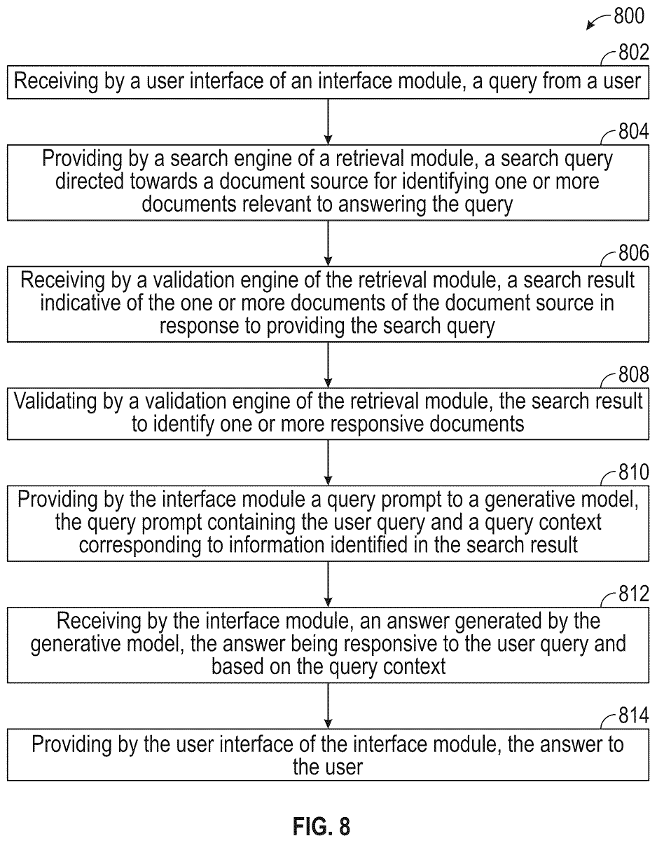

At block 710, method 700 continues with dividing the document into a plurality of chunks based on the third set of matched chapter headers. As previously described, pattern matching or text manipulation algorithms (e.g., Regex algorithm) may be applied to the text of the third set of matched chapter headers to split the third set of matched chapter headers into segments or chunks of data for faster processing. Method 700 continues at block 712 with storing the plurality of chunks of the document in a datastore for later retrieval. In some embodiments, the plurality of chunks is embedded and then saved in a vector database. Alternatively, the plurality of chunks may be stored in a data structure other than a vector database such as a SQL database and the like. In some embodiment, the extracted chapters are indexed with their corresponding chapter headers when the chunks are stored as part of an index or other data structure. Referring now to FIG. 8, an embodiment of another computer-implemented method 800 for answering queries is shown. At least some, if not all, of the steps or “blocks” of method 800 shown in FIG. 8 may be executed by the computer system 500 shown in FIG. 6, although it is to be understood that at least some of the steps of method 800 may be executed by systems other than computer system 500. Additionally, it may be understood that the generation of answers described by method 800 may be used for a variety of purposes, including information retrieval and in business/customer support applications. Particularly, and as further discussed below, method 800 may incorporate at least some of the features or steps of Q&A system 10/method 100/method 700 described above. Beginning at block 802 method 800 includes receiving by a user interface of an interface module, a query from a user. As previously described, the query may be in the form of a question in natural language or text, graphical elements, etc. For example, a user may input a query into a text input field of the user interface. The text input field may include helpful features, such as, auto-suggestions, predefined categories, or keywords that enhance overall user experience and streamline the Q&A process. In some embodiments, the query may be a single question from which an associated answer can be determined or multiple questions. Method 800 continues at block 804 with providing by a search engine of a retrieval module, a search query directed towards a document source for identifying one or more documents relevant to answering the query. As previously described, the search engine may perform a target search of a document source to retrieve one or more documents in response to receiving the user query. In some embodiments, the query is chunked to extract the meaning within the query prior to searching the document source to ensure that the system retrieves only the most pertinent information. At block 806, method 800 continues with receiving by a validation engine of the retrieval module, a search result indicative of the one or more documents of the document source in response to providing the search query. Method 800 continues at block 808 with validating by the validation engine of the interface module, the search result to identify one or more responsive documents. As previously described, the validation engine may compare the search results with the query to identify relevant documents. For example, validation engine 26 may compare documents retrieved by the search engine with the user query to ensure the information in the documents retrieved is aligned with the query. In this manner, the validation engine functions as a gatekeeper ensuring that the retrieved document aligns with the scope of the query.

At block 810, method 800 continues with providing by the interface module a query prompt to a generative model, the query prompt containing the user query and a query context corresponding to information identified in the search result. Once the search result is validated by the validation engine, the user query and the query context identified in the search result is provided to a generative model to generate an answer responsive to the query. The generative model is pre-trained based on outside data and coupled to the system via internet or other network. Method 800 continues at block 812 with receiving by the interface module an answer generated by the generative module, the answer being responsive to the user query and based on the query context. In this manner, the generative model provides the answer based on the query and the context provided only. At block 814, method 800 continues with providing by the user interface of the interface module, the answer to the user. In some embodiments, the answer may be formatted for clarity, converted into a usable format etc., and returned to the user.

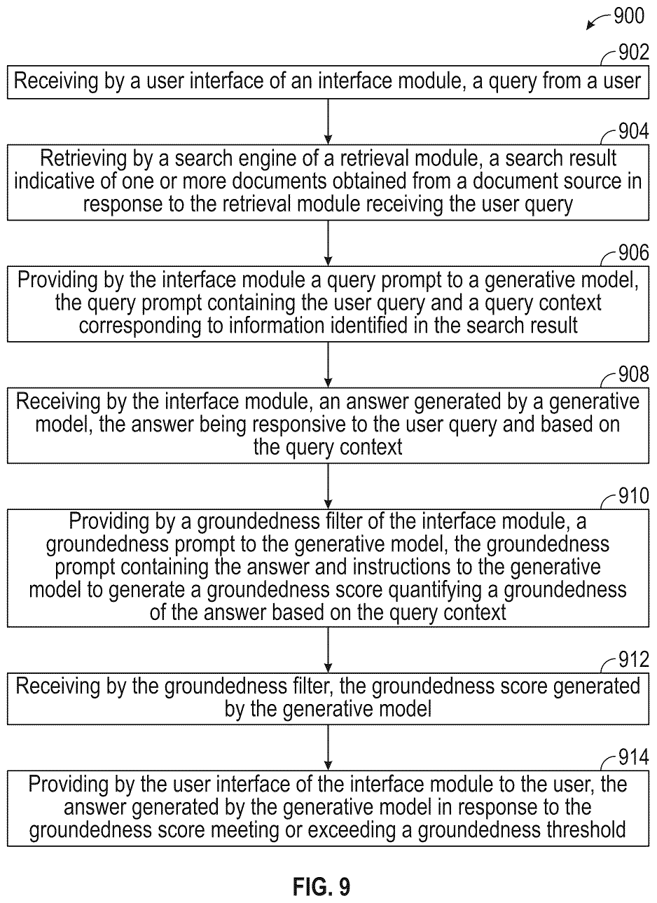

Referring now to FIG. 9, an embodiment of another computer-implemented method 900 for answering queries is shown. At least some, if not all, of the steps or “blocks” of method 900 shown in FIG. 9 may be executed by the computer system 500 shown in FIG. 6, although it is to be understood that at least some of the steps of method 900 may be executed by systems other than computer system 500. Additionally, it may be understood that the generation of answers described by method 900 may be used for a variety of purposes, including information retrieval and in business/customer support applications. Particularly, and as further discussed below, method 900 may incorporate at least some of the features or steps of Q&A system 10/method 100/method 700 and method 800 described above.

Beginning at block 902 method 900 includes receiving by a user interface of an interface module, a query from a user. As previously described, the query may be in the form of a question in natural language or text, graphical elements, etc. For example, a user may input a query into a text input field of the user interface. The text input field may include helpful features, such as, auto-suggestions, predefined categories, or keywords that enhance overall user experience and streamline the Q&A process. In some embodiments, the query may be a single question from which an associated answer can be determined or multiple questions.

Method 900 continues at block 904 with retrieving by a search engine of a retrieval module, a search result indicative of one or more documents obtained from a document source in response to the retrieval module receiving the user query. As previously described, the search engine may perform a target search of a document source to retrieve one or more documents in response to receiving the user query. In some embodiments, the query is chunked to extract the meaning within the query prior to searching the document source to ensure that the system retrieves only the most pertinent information.

At block 906, method 900 continues with providing by the interface module a query prompt to a generative model, the query prompt containing the user query and a query context corresponding to information identified in the search result. As previously described, the user query and the one or more retrieved documents and the information therein is provided to the generative model to generate an answer responsive to the query.

Method 900 continues at block 908 with receiving by the interface module an answer generated by the generative model, the answer being responsive to the user query and based on the query context. At block 910, method 900 continues with providing by a groundedness filter of the interface module, a groundedness prompt to the generative model, the groundedness prompt containing the answer and instructions to the generative model to generate a groundedness score quantifying a groundedness of the answer based on the query context. As previously described, the term “groundedness score” refers to the extent to which the response or answer is based on the query context versus other information such as information obtained from training dataset used in training the generative model.

Method 900 continues at block 912 with receiving by the groundedness filter the groundedness score generated by the generative model. As previously described, the groundedness score generated by the generative model is provided to the groundedness filter to evaluate the quality of the response. At block 914, method 900 continues with providing by the user interface of the interface module to the user, the answer generated by the generative model in response to the groundedness score meeting or exceeding a groundedness threshold. As previously described, the groundedness score may be compared to a predefined threshold. For example, when the groundedness score is at or above the predefined threshold, the response generated by the generative model may be provided as an answer to the user. Conversely, when the groundedness score is below the predefined threshold, a different response may be generated and the groundedness score compared again to the predefined threshold. The process may repeat until the groundedness score falls at or above the predefined threshold.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for answering queries received by a user, the method comprising:
(a) receiving by a document processing module a document from a document source;
(b) identifying by a document chunking engine of the document processing module a first set of chapter headers contained in a table of contents of the document;
(c) identifying by the document chunking engine a second set of chapter headers in a body of the document that is separate from the table of contents;
(d) matching by the document chunking engine one or more chapter headers of the first set of chapter headers with one or more chapter headers of the second set of chapter headers to provide a third set of matched chapter headers;
(e) dividing the document into a plurality of chunks based on the third set of matched chapter headers; and
(f) storing the plurality of chunks of the document in a datastore.

2. The method of claim 1, further comprising:
(g) embedding the plurality of chunks as a plurality of multi-dimensional vectors;
wherein (f) comprises storing the plurality of chunks as the plurality of vectors in the datastore.

3. The method of claim 1, wherein (c) comprises:
(c1) providing a prompt to a generative model instructing the generative model to identify the second set of chapter headers in the body of the document; and
(c2) receiving from the generative model the second set of chapter headers.

4. The method of claim 3, wherein (c1) comprises iteratively providing a set of the prompts to the generative model associated with different portions of the body of selected document.

5. The method of claim 4, wherein (c2) comprises receiving iteratively from the generative model the second set of chapter headers.

6. The method of claim 1, wherein each of the plurality of chunks corresponds to a unique chapter of the body of the document.

7. The method of claim 1, wherein at least some of the plurality of chunks corresponds to a unique chapter of the body of the document.

8. A computer-implemented method for answering queries received by a user, the method comprising:
(a) receiving by a user interface of an interface module a user query from a user;
(b) providing by a search engine of a retrieval module a search query directed towards a document source for identifying one or more documents relevant to answering the query;
(c) receiving by a validation engine of the retrieval module a search result indicative of one or more documents of the document source in response to providing the search query;
(d) validating by the validation engine the search result to identify one or more responsive documents;
(e) providing by the interface module a query prompt to a generative model, the query prompt containing the user query and a query context corresponding to information identified in the search result;
(f) receiving by the interface module an answer generated by the generative model, the answer being responsive to the user query and based on the query context; and
(g) providing by the user interface of the interface module the answer to the user.

9. The method of claim 8, further comprising:
(h) dividing by a query chunking engine of a query processing module the query into a plurality of chunks.

10. The method of claim 9, further comprising:
(i) embedding by a query embedding engine of the query processing module the plurality of chunks as an embedded query comprising a plurality of multi-dimensional query vectors.

11. The method of claim 8, further comprising:
(h) identifying by a scope identification engine, if the query is within a predefined answer scope.

12. The method of claim 11, wherein (h) comprises:
(h1) providing by the scope identification engine a scope prompt instructing the generative model to generate a scope determination of the query; and
(h2) receiving by the scope identification engine 24 the scope determination generated by the generative model.

13. The method of claim 12, wherein the scope prompt both instructs the generative model to generate a scope explanation if the query is within the answer scope, and to determine if the query is within the answer scope based on the scope explanation.

14. The method of claim 8, wherein (b) comprises iteratively providing by the search engine of a retrieval module a set of different search queries directed towards the document source.

15. The method of claim 14, wherein (c) comprises receiving iteratively by the validation engine a set of different search results until a final search result is received that addresses each of one or more answer requirements determined by the retrieval module that must be addressed in order to generate a valid answer.

16. A computer-implemented method for answering queries received by a user, the method comprising:
(a) receiving by a user interface of an interface module a user query from a user;
(b) retrieving by a search engine of a retrieval module a search result indicative of one or more documents obtained from a document source in response to the retrieval module receiving the user query;
(c) providing by the interface module a query prompt to a generative model, the query prompt containing the user query and a query context corresponding to information identified in the search result;
(d) receiving by the interface module an answer generated by a generative model, the answer being responsive to the user query and based on the query context;
(e) providing by a groundedness filter of the interface module a groundedness prompt to the generative model, the groundedness prompt containing the answer and instructions to the generative model to generate a groundedness score quantifying a groundedness of the answer based on the query context;
(f) receiving by the groundedness filter the groundedness score generated by the generative model; and
(g) providing by the user interface of the interface module to the user, the answer generated by the generative model in response to the groundedness score meeting or exceeding a groundedness threshold.

17. The method of claim 16, wherein the groundedness prompt comprises both instructions to generate a groundedness explanation of the groundedness of the answer, and to determine the groundedness score based on the groundedness explanation.

18. The method of claim 16, further comprising:
(h) providing by the groundedness filter an updated groundedness prompt to the generative model instructing the generative model to provide an updated answer having a groundedness score that exceeds the groundedness threshold.

19. The method of claim 16, wherein the groundedness score corresponds to an amount of information contained in the answer that is included in the query context.

20. The method of claim 16, wherein:
(f) comprises receiving by the groundedness filter an updated groundedness score generated by the generative model and based on an updated answer; and
(g) comprises providing by the user interface of the interface module to the user, the answer generated by the generative model in response to the updated groundedness score meeting or exceeding the groundedness threshold.
